(19) United States
(12) Patent Application Publication
(10) Pub. No.: US 2017/0263927 A1
(43) Pub. Date: Sep. 14, 2017

(54) ELECTRODE, MANUFACTURING METHOD THEREOF AND SECONDARY BATTERY COMPRISING THE SAME

(71) Applicant: LG CHEM, LTD., Seoul (KR)

(72) Inventors: Hyo-Sik KIM, Daejeon (KR); Hye-Ran JUNG, Daejeon (KR); Song-Taek OH, Daejeon (KR); Hyeok-Moo LEE, Daejeon (KR)

(73) Assignee: LG CHEM, LTD., Seoul (KR)

(21) Appl. No.: 15/529,599

(22) PCT Filed: Feb. 16, 2016
(86) PCT No.: PCT/KR2016/001563

§ 371 Date: May 25, 2017

(30) Foreign Application Priority Data
Feb. 16, 2015 (KR) 10-2015-0023500

(51) Int. Cl. H01M 4/36; H01M 4/62; H01M 4/04

(52) U.S. Cl. CPC H01M 4/366; H01M 4/0435; H01M 4/0404; H01M 4/624; H01M 4/622; H01M 2004/021

(57) ABSTRACT

Disclosed is an electrode including an electrode comprising: an electrode current collector; and two or more electrode active material layers stacked on at least one surface of the electrode current collector, each of the electrode active material layers comprising an electrode active material, a conductor, and a binder, wherein the binder is uniformly distributed along a thickness direction of each of the electrode active material layer.

### TECHNICAL FIELD

The present disclosure relates to an electrode, more particularly an electrode with enhanced adhesion and output, a manufacturing method thereof, and a secondary battery comprising the same.

The present application claims priority to Korean Patent Application No. 10-2015-0023500 filed on Feb. 16, 2015, the disclosure of which is incorporated herein by reference.

### BACKGROUND ART

Recently, interest in energy storing technologies continues to increase. As application areas expand to energies for mobile phones, camcorders and notebook PCs and further to electric vehicles, more systematic efforts are made for the researches and developments of electrochemical devices.

In this aspect, electrochemical device area is in the center of the attentions, and in particular, development of chargeable and dischargeable lithium secondary batteries is becoming a focus of attention. One of the recent efforts to develop such batteries is the research and development of new electrode and battery designs that is currently underway to improve capacity density and specific energy.

The lithium secondary battery is manufactured by forming an anode and a cathode from a material allowing the intercalation and deintercalation of lithium ions and filing an organic electrolyte or polymer electrolyte between the cathode and the anode, in which electrical energy is generated from oxidation and reduction of the lithium ions being intercalated and deintercalated into or from the cathode and the anode.

Each of the anode and the cathode comprise an electrode active material layer formed on a current collector. For example, an electrode may be prepared by mixing a binder and a solvent, and if necessary a conductor and a dispersant and stirring the mixture to prepare a slurry, and then applying the slurry on the current collector made of a metal, followed by pressing and drying.

An example of the binder includes polytetrafluoroethylene (PTFE), polyvinylidene fluoride (PVDF) or the like, and an example of the conductor mainly includes carbon black.

In known commercialized batteries, each of the anode and the cathode generally comprises one electrode layer formed by coating the electrode slurry described above on each current collector only once, but in this case, the binder distribution in a cross section of the electrode layer is measured to exhibit increased binder content near the surface of the electrode layer, while exhibiting gradually decreased binder content along a direction toward the current collector.

Accordingly, there is a limit in output because the electrode shows poor adhesion due to decreased content of the binder near the current collector, and the composition of electrode components is varied at respective locations along a thickness direction of the electrode. Accordingly, it is still necessary to develop an electrode having a uniform composition across the locations.

### DISCLOSURE

### Technical Problem

The present disclosure is designed to solve the problems of the related art, and therefore the present disclosure is directed to providing an electrode having uniform distribution of a binder at respective locations along a thickness direction, a manufacturing method of the electrode, and a secondary battery comprising the electrode.

These and other objects and advantages of the present disclosure may be understood from the following detailed description and will become more fully apparent from the embodiments of the present disclosure. Also, it will be easily understood that the objects and advantages of the present disclosure may be realized by the means shown in the appended claims and combinations thereof.

### Technical Solution

In one aspect of the present disclosure, there is provided an electrode comprising: an electrode current collector; and two or more electrode active material layers stacked on at least one surface of the electrode current collector, each of the electrode active material layers comprising an electrode active material, a conductor, and a binder, wherein the binder is uniformly distributed along a thickness direction of each of the electrode active material layer.

When the whole of the two or more electrode active material layers is divided into a lower layer, a middle layer, and an upper layer in a thickness direction from a lower portion opposing the electrode current collector to a surface of the electrode active material layer, the lower layer may have a binder content of 0.4 to 1.8 times relative to the upper layer.

The middle layer may have a binder content of 0.6 to 1.8 times relative to the upper layer.

Each of the electrode active material layers may have a thickness of 5 to 100 μm, and the whole of the electrode active material layers has a thickness of 10 to 500 μm.

The electrode may be an anode or a cathode.

In another aspect of the present disclosure, there is also provided a secondary battery comprising the electrode described above.

In another aspect of the present disclosure, there is provided a method for manufacturing an electrode, comprising steps of:

(a) preparing an electrode slurry by mixing an electrode active material, a conductor, a binder and a solvent;

(b) coating the electrode slurry on a surface of an electrode current collector;

(c) removing the solvent by drying the electrode slurry coated on the electrode current collector;

(d) forming an electrode active material layer by roll-pressing the electrode slurry from which the solvent is removed; and

(e) repeating the steps of (b) to (d) sequentially n times (1≦n≦5) to form another electrode active material layers.

The step of removing the solvent may be carried out by drying the electrode slurry within 10 minutes so that the electrode active material layer is adhered onto an upper portion of the electrode current collector.

The step of roll-pressing may be carried out so that a porosity of each electrode active material layer reaches 25 to 50%, except for an outermost electrode active material layer.

In an example, the whole of the electrode active material layers may have a porosity being adjusted by a pressure applied during roll-pressing of the outermost electrode active material layer.

In yet another aspect of the present disclosure, there is also provided an electrode manufactured with the above method.

Further, in yet another embodiment of the present disclosure, there is also provided a secondary battery comprising the electrode described above.

### Advantageous Effects

The electrode according to the present disclosure comprises two or more electrode active material layers to have uniform binder distribution on the surface of an electrode current collector, thereby providing good adhesion between the electrode current collector and the electrode active material layers. The electrode can be used in fabrication of a battery to provide enhanced capacity and output.

Further, the present disclosure includes a roll-pressing process for preparing an optimized porosity to provide maximized output density.

### DESCRIPTION OF DRAWINGS

The accompanying drawings illustrate a preferred embodiment of the present disclosure and together with the foregoing disclosure, serve to provide further understanding of the technical features of the present disclosure, and thus, the present disclosure is not construed as being limited to the drawing.

FIG. 1 is a schematic diagram of an electrode according to an exemplary embodiment.

FIG. 2 is a schematic diagram of an electrode according to an exemplary embodiment.

FIG. 3 is an expanded diagram of entire electrode active material layers according to an exemplary embodiment.

FIG. 4 is a flowchart provided to explain an electrode manufacturing method according to an exemplary embodiment.

FIG. 5 is a graph illustrating adhesion of Example 1 and Comparative Example 1.

FIG. 6 is a graph illustrating battery capacity of Example 1 and Comparative Example 1.

FIG. 7 is a graph illustrating battery resistance of Example 1 and Comparative Example 1.

FIG. 8 is a graph illustrating a binder distribution in a thickness direction of Example 1 and Comparative Example 1.

### BEST MODE

Hereinafter, preferred embodiments of the present disclosure will be described in detail with reference to the accompanying drawings. Prior to the description, it should be understood that the terms used in the specification and the appended claims should not be construed as limited to general and dictionary meanings, but interpreted based on the meanings and concepts corresponding to technical aspects of the present disclosure on the basis of the principle that the inventor is allowed to define terms appropriately for the best explanation. Therefore, the embodiments disclosed in the present specification and the configurations illustrated in the drawings are merely the most preferred embodiments of the present disclosure, and not all of them represent the technical ideas of the present disclosure, and thus it should be understood that there may be various equivalents and modified examples that could substitute therefor at the time of filing the present application.

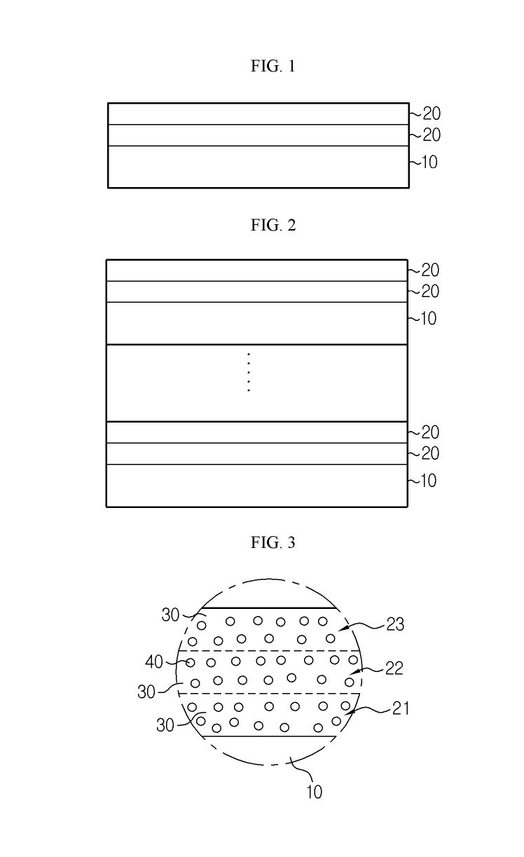

FIGS. 1 and 2 are schematic cross-sectional views of an electrode according to an exemplary embodiment. Referring to FIGS. 1 and 2, the electrode 100 according to an exemplary embodiment comprises an electrode current collector 10, and two or more electrode active material layers 20 stacked on at least one surface of the electrode current collector 10. The electrode active material layers 20 may comprise an electrode active material, a conductor and a binder, and the binder may be uniformly distributed in a thickness direction of each of the electrode active material layers 20.

In an example, the electrode may be positive or anode, and accordingly, the following explanation may be commonly applied to both the anode and the cathode, unless the anode and the cathode are specifically distinguished from each other in certain embodiments.

The electrode current collector may not be limited to any specific example as long as it has high conductivity and does not cause a chemical change in the related art, and may include, as a non-limiting example, copper; stainless steel; aluminum; nickel; titanium; sintered carbon; copper; stainless steel surface-treated with carbon, nickel, titanium or silver; and a material surface-treated with aluminum-cadmium alloy, or the like.

Further, the electrode current collector may have micro unevenness formed on the surface thereof to enhance the adhesion of the cathode active material, and may have various forms such as film, sheet, foil, net, porous body, foam, nonwoven fabric, and so on, and may have a thickness of 3 to 500 μm.

The electrode active material layer may be formed into two or more layers, and preferably, 2 to 5 layers, on at least one surface of the electrode current collector.

In conventional electrodes comprising a single layer of electrode active material layer, the procedure of coating an electrode slurry and roll-pressing the coating is conducted only one and thus it requires long time for evaporation of solvent, which also increases time for the binder to be self-aggregated so as to have a lower energy state. Accordingly, a binder distribution in the electrode having a single electrode active material layer is measured to exhibit higher binder content near the surface of the electrode active material layer, while exhibiting decreased binder content along in a direction toward the current collector. The decreased binder content near the electrode current collector results in reduced adhesion and varies the composition of the components at respective locations along a thickness direction, thereby making the electrode difficult to provide optimized output.

On the other hand, according to the present disclosure, a multi-layered electrode active material is formed by two or more procedures of coating an electrode slurry and roll-pressing the coating, which can reduce the time for evaporation of solvent to decrease the time for the binder to be self-aggregated, thereby reducing the change of binder distribution according to thickness direction.

That is, the electrode according to an embodiment of the present disclosure may have uniform distribution of the binder in a thickness direction of each electrode active material layer.

Specifically, referring to FIG. 3, which is an expanded diagram of the entire electrode active material layers according to an embodiment, the whole electrode active material layer where two or more electrode active material layers are stacked may be divided into a lower layer 21, a middle layer 22, and an upper layer 23 in a thickness direction from a lower portion opposing the electrode current collector to the surface of the electrode active material layer, in which a binder 30 and an electrode active material 40 may be distributed on each layer, and specifically, the content ratio of the binder in the lower layer 21 relative to the upper layer 23 may range from 0.4 to 1.8, and preferably, from 0.5 to 1.62.

Further, the content ratio of the binder in the middle layer 22 relative to the upper layer 23 may range from 0.6 to 1.7, and preferably, 0.8 to 1.7.

The electrode active material layer applicable in the present disclosure may comprise an electrode active material, a conductor and a binder, and the electrode active material may be a cathode active material or an anode active material according to the type of the applied electrode.

More specifically, when the applied electrode is an anode, a non-limiting example of the anode active material may include carbon such as non-graphitizable carbon and graphite-based carbon; metal composite oxide such as LixFe₂O₃ (0≦x≦1), LiₓWO₂ (0≦x≦1), SnₓMe₁₋ₓMe′_{y}O_{z} (Me: Mn, Fe, Pb, Ge; Me′: Al, B, P, Si, elements of Groups 1, 2 and 3 in the periodic table, halogen; 0<x≦1; 1≦y≦3; 1≦z≦8); lithium metal; lithium alloy; silicon-based alloy; tin-based alloy; metal oxide such as SnO, SnO₂, PbO; conductive polymer such as polyacethylene; and Li-Co-Ni-based material, and the like.

Further, when the applied electrode is the cathode, non-limiting examples of the cathode active material may include LiCoO₂, LiNiO₂, LiMn₂O₄, LiCoPO₄, LiFePO₄, LiNiMnCoO₂ and LiNi_{1-x-yz}CoₓM1_{y}M2_{z}O₂ (where, M1 and M2 are any one independently selected from a group consisting of Al, Ni, Co, Fe, Mn, V, Cr, Ti, W, Ta, Mg and Mo, and x, y and z are each independently an atomic fraction of oxide-forming elements, in which 0≦x<0.5, 0≦y<0.5, 0≦z<0.5, 0<x+y+z≦1).

The conductor may not be limited to any specific example as long as it has conductivity and does not cause a chemical change in the related art, and non-limiting examples may include a conductive material which may be graphite such as natural graphite or artificial graphite; carbon black such as carbon black, acetylene black, ketjen black, channel black, furnace black, lamp black, or thermal black; conductive fiber such as carbon fiber or metal fiber; metal powder such as fluorocarbon, aluminum, or nickel powder; conductive whisker such as zinc oxide or potassium titanate; conductive metal oxide such as titanium oxide; and polyphenylene derivatives. Preferably, the conductor may be at least any one selected from the group consisting of graphite, carbon black, acethylene black, ketjen black, channel black, furnace black, lamp black, thermal black, carbon fiber, metal fiber, fluorocarbon, aluminum powder, nickel powder, zinc oxide, potassium titanate, and titanium oxide, and may generally be added in an amount from about 1 wt to 20 wt % based on the total weight constituting the electrode active material layer.

Further, any component may be used as the binder applicable in the present disclosure without limitations as long as the component contributes to bonding of the electrode active material and the conductor and to bonding to the electrode current collector. The component may preferably be at least one selected from the group consisting of polyvinylidene fluoride, vinyldene fluoride-hexafluoropropylene copolymer (PVDF-co-HFP), polyvinyl alcohol, carboxymethyl cellulose (CMC), starch, hydroxypropylcellulose, regenerated cellulose, polyvinylpirrolidone, polytetrafluoroethylene, polyethylene, polypropylene, ethylene-propylene-diene ter polymer (EPDM), sulfonated EPDM, styrene butadiene rubber (SBR), fluorine rubber, polyacrylonitrile and polymethylmetacrylate, and may generally be added in an amount from 1 to 20 wt % based on the total weight constituting the electrode active material layer.

Optionally, the electrode active material layer may further include a filler, and may generally be added in an amount of 1 to 20 wt % based on the total weight constituting the electrode active material layer.

Each of the electrode active material layers formed as described above may have a thickness of 5 to 100 μm, and preferably, 15 to 80 μm. When exceeding 100 μm, it may deteriorate adhesion because non-uniform distribution of the binder in each electrode active material layer remains even after the electrode active material layers are stacked.

Further, the whole electrode active material layers where each electrode active material layer is stacked may have a thickness of 10 to 500 μm, and preferably, 30 to 200 μm. When exceeding 500 μm, it may make a problem in expression of the battery capacity or the like because an electrolyte is not sufficiently delivered to the entire electrode active material layers.

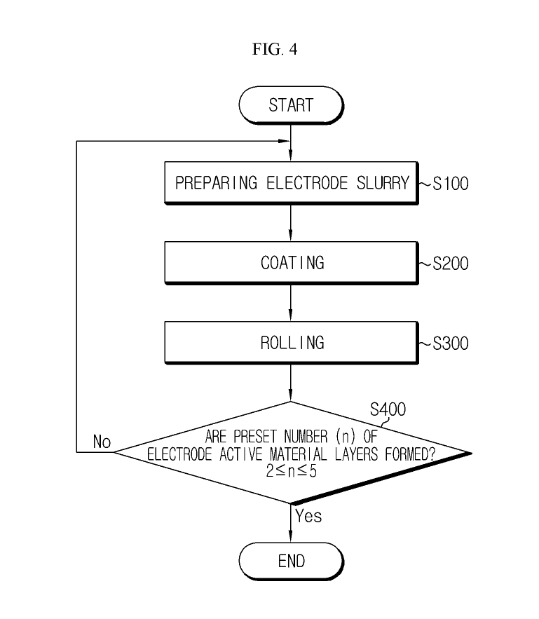

Referring to FIG. 4, which is a flowchart illustrating an electrode manufacturing method according to another embodiment, the method comprises steps of preparing an electrode slurry (S100), coating (S200), roll-pressing (S300), and repeating the steps described above (S400).

The step of preparing an electrode slurry is to obtain an electrode slurry to be coated on a surface of the electrode current collector, by mixing an electrode active material, a conductor, a binder and a solvent.

The electrode active material, the conductor, and the binder that can be used to the step of preparing an electrode slurry may be the same described above in relation to the electrode.

The solvent may be used without limitations as long as it does not cause a chemical change in the related art, has a low boiling point for easy removal thereafter, the electrode active material, the conductor, and the binder are not dissolved. Non-limiting examples may include acetone, tetrahydrofuran, methylene chloride, chloroform, dimethylformamide, or the like.

The step of coating is to apply the electrode slurry prepared in the above on the surface of the electrode current collector by a coating method generally used in the art, without limitations. Non-limiting examples of the coating may include various methods such as dip coating, die coating, roll coating, comma coating or a mixed method thereof.

In an example, an amount of the coated electrode slurry may be differently adjusted according to a total intended thickness/total intended number of layers of the electrode active material layers.

The step of removing the solvent is carried out by way of sintering or curing of the electrode slurry to remove the solvent so as to adhere the electrode slurry onto the surface of the electrode current collector. Also, the removal of the solvent may be carried out by applying a temperature equal to or greater than a boiling point of the solvent.

In an example, the step of removing the solvent to adhere the coated electrode slurry onto the surface of the electrode current collector is performed within 10 minutes, or preferably, within 5 minutes. When the solvent removing time exceeds 10 minutes, the binder within the electrode slurry is self-aggregated and the binder content in the upper layer increases relative to the lower layer. As a result, adhesion decreases due to difference in the binder contents between the upper layer and the lower layer.

Further, in the step of removing the solvent, it is not necessary that the solvent is completely removed. That is, it is sufficient that the solvent is removed to an extent to remove fluidity of the electrode slurry.

The step of roll-pressing is to press the coating of the electrode slurry from which the solvent is removed, to prepare the electrode active material layer.

The step of repeating the above processes is performed after the preparation of a single layer of the electrode active material layer, and may involve stacking two or more electrode active material layers by repeating the steps of coating as many times as the number (n) of layers, removing the solvent, and roll-pressing for n times.

In an example, the number (n) of layers of the electrode active material layers may be 2 to 5. When exceeding 5 layers, process control may be difficult.

During the repeating step, the roll-pressing step may preferably press the slurry coating until the porosity of each electrode active material layer reaches 25 to 50 wt %, and preferably, 40 wt %, except for the roll-pressing of an outermost electrode active material layer. The roll-pressing of the outermost electrode active material layer may preferably carried out to meet the intended porosity of the whole electrode active material layers.

Further, according to another embodiment, a vacuum drying process may be further included for complete removal of the solvent within the electrode after the roll-pressing step, in which vacuum drying time may be different according to the solvent used.

According to an embodiment, an electrode manufactured as described above is provided, and a secondary battery comprising the electrode is provided.

Hereinafter, for more specific description, the present disclosure will be described in detail with reference to Examples. However, Examples according to an embodiment can be modified in various forms, and the scope of the present disclosure is not to be construed as being limited to Examples described below. The Examples according to the present disclosure are provided in order to give more complete description of the present disclosure to those having average knowledge in the art.

### Example 1

An electrode slurry comprising electrode active material, conductor and binder in the ratio of 96 wt %, 1.5 wt % and 2.5 wt %, respectively, in the solvent, was coated on a 20 μm-thick electrode current collector using a comma coater. At this time, an amount of the electrode to material per unit area was the half the electrode material to be finally produced, and heating was performed at 130 □ for the solvent removal. The electrode prepared at the first coating was rolled until porosity reached 40%.

The electrode slurry having the same composition as used in the first coating was secondly coated using the comma coater on an upper portion of the electrode prepared as described above. For the second coating, an amount of the electrode material per unit area was set to be identical to that of the first coating so that a target amount of the finished electrode material per unit area was identical to that of the first coating.

Further, roll-pressing was performed so that the porosity of the whole electrode active material layer reached 26%. If the second coating is carried out without roll-pressing of the first coating, the solvent within the electrode slurry used in the second coating dissolves the previously-coated electrode active material layer to cause the release of the electrode active material from the current collector. The roll-pressing of the first coating should be essentially carried out. The electrode prepared as described above was measured for the adhesion between the electrode active material layer and the electrode current collector and also for the binder distribution according to a thickness, and further, capacity and resistance of a battery manufactured with the electrode described above were also measured.

### Comparative Example 1

An electrode slurry comprising electrode active material, conductor and binder in the ratio of 96 wt %, 1.5 wt % and 2.5 wt %, respectively, in the solvent, was coated on a 20 μm-thick electrode current collector using a comma coater. At this time, an amount of the electrode material per unit area was set to be same as the while electrode active material layer of Example 1, and roll-pressing was also carried out so that the porosity of the electrode active material was identical, i.e., 26%. The electrode prepared as described above was measured for the adhesion between the electrode active material layer and the electrode current collector and also for the binder distribution according to a thickness, and further, capacity and resistance of a battery manufactured with the electrode described above were also measured.

FIG. 5 is a graph illustrating adhesion of Example 1 and Comparative Example 1. Referring to FIG. 5, the electrode of Example 1 shows superior adhesion than the electrode of Comparative Example 1.

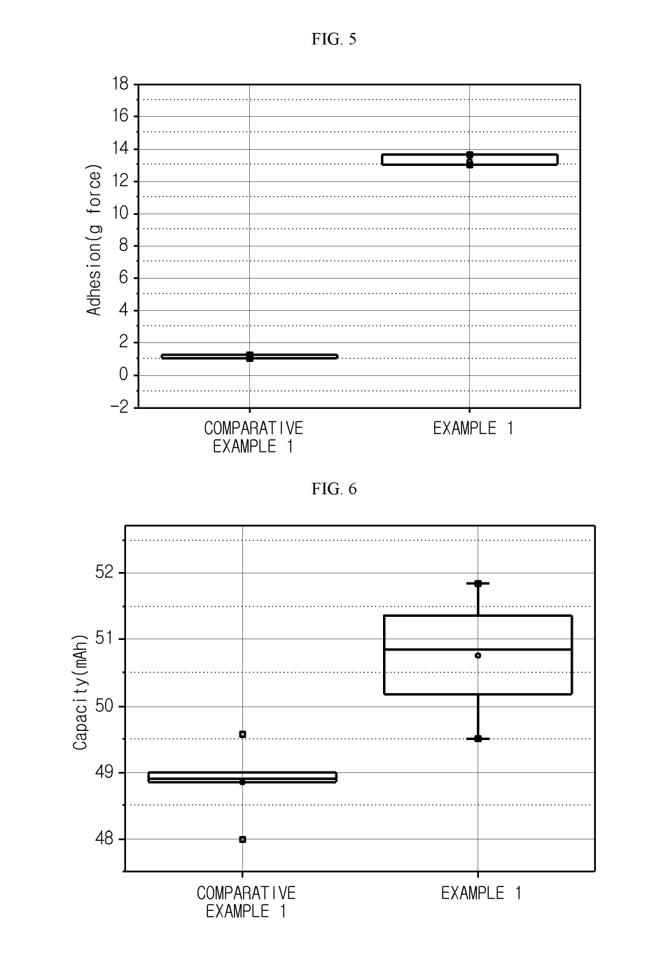

Further, FIG. 6 is a graph illustrating battery capacity of Example 1 and Comparative Example 1. Referring to FIG. 6, Example 1 shows higher electric capacity as compared to Comparative Example 1 because the spreading of the electrolyte within the electrode active material layers is enhanced due to uniform distribution of the binder within the electrode active material layers manufactured in Example 1.

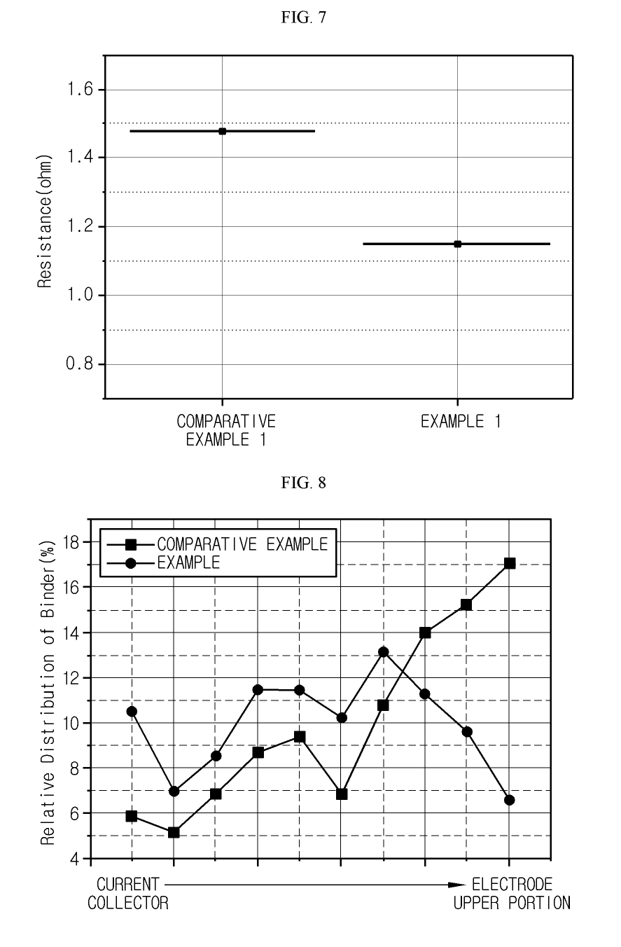

Further, FIG. 7 is a graph illustrating battery resistance of Example 1 and Comparative Example 1. Referring to FIG. 7, the electrode manufactured in Example 1 shows lower resistance as compared to Comparative Example 1.

FIG. 8 is a graph illustrating measurements of the binder distribution in a thickness direction of Example 1 and Comparative Example 1. The electrode manufactured in Example 1 shows more uniform distribution of the binder as compared to Comparative Example 1.

The present disclosure has been described in detail. However, it should be understood that the detailed description and specific examples, while indicating preferred embodiments of the disclosure, are given by way of illustration only, and various changes and modifications within the scope of the disclosure will become apparent to those skilled in the art from this detailed description.

1. An electrode comprising:
an electrode current collector; and
two or more electrode active material layers stacked on at least one surface of the electrode current collector, each of the electrode active material layers comprising an electrode active material, a conductor, and a binder,
wherein the binder is uniformly distributed along a thickness direction of each of the electrode active material layer.

2. The electrode of claim 1, wherein when the whole of the two or more electrode active material layers is divided into a lower layer, a middle layer, and an upper layer in a thickness direction from a lower portion opposing the electrode current collector to a surface of the electrode active material layer, the lower layer has a binder content of 0.4 to 1.8 times relative to the upper layer.

3. The electrode of claim 2, wherein the middle layer has a binder content of 0.6 to 1.8 times relative to the upper layer.

4. The electrode of claim 1, wherein each of the electrode active material layers has a thickness of 5 to 100 μm, and the whole of the electrode active material layers has a thickness of 10 to 500 μm.

5. The electrode of claim 1, wherein the electrode is an anode or a cathode.

6. A secondary battery comprising the electrode of claim 1.

7. A method for manufacturing an electrode, comprising steps of:
(a) preparing an electrode slurry by mixing an electrode active material, a conductor, a binder and a solvent;
(b) coating the electrode slurry on a surface of an electrode current collector;
(c) removing the solvent by drying the electrode slurry coated on the electrode current collector;
(d) forming an electrode active material layer by roll-pressing the electrode slurry from which the solvent is removed; and
(e) repeating the steps of (b) to (d) sequentially n times (1≦n≦5) to form another electrode active material layers.

8. The electrode of claim 7, wherein the step of removing the solvent is carried out by drying the electrode slurry within 10 minutes so that the electrode active material layer is attached onto an upper portion of the electrode current collector.

9. The electrode of claim 7, wherein the step of roll-pressing is carried out so that a porosity of each electrode active material layer reaches 25 to 50%, except for an outermost electrode active material layer.

10. The electrode of claim 7, wherein the whole of the electrode active material layers has a porosity being adjusted by a pressure applied during roll-pressing of the outermost electrode active material layer.

11. An electrode manufactured by the method of claim 7.

12. A secondary battery comprising the electrode of claim 11.
